(19) United States
(12) Patent Application Publication
(10) Pub. No.: US 2025/0205897 A1
(43) Pub. Date: Jun. 26, 2025

(54) HIGH SPEED ACTUATOR-BASED ITEM REGISTRATION SYSTEM

(71) Applicant: Sony Semiconductor Solutions Corporation, Kanagawa (JP)

(72) Inventor: Andreas AUMILLER, Stuttgart (DE)

(73) Assignee: Sony Semiconductor Solutions Corporation, Kanagawa (JP)

(21) Appl. No.: 18/848,142

(22) PCT Filed: Mar. 9, 2023
(86) PCT No.: PCT/EP2023/056052

§ 371 Date: Sep. 18, 2024

(30) Foreign Application Priority Data
Mar. 30, 2022 (EP) 22165565.7

(51) Int. Cl. B25J 9/16; G06T 7/00

(52) U.S. Cl. CPC B25J 9/1697; G06T 7/0002

(57) ABSTRACT

A system comprising circuitry configured to perform a vision-based registration task, the circuitry being coupled with an event-based vision sensor and being configured to be adaptive to inference quality derived from output of the event-based vision sensor and/or to be adaptive to consistency of a task output of the vision-based registration task.

### TECHNICAL FIELD

The present disclosure generally pertains to the field of computer vision.

### TECHNICAL BACKGROUND

Computer vision deals with how computers can gain high-level understanding from digital images or videos. From the perspective of engineering, it seeks to understand and automate tasks that the human visual system can do.

With the ever more sophisticated and diversified needs of the industrial equipment business, the use of sensing to extract the necessary information from images captured by cameras continues to grow, demanding ever more efficient data acquisition.

Currently, most warehouse management tasks, such as item search, cycle counting and stock taking, are conducted manually and thus are labor-intensive. Manual stock taking is an example of a process that is extremely time-consuming. The activity requires human resources, who also need a pallet truck or forklift. At the same time, it involves a high error rate and a not insignificant risk of accidents. The fundamental shortage of skilled workers and increasing time pressure cause costly errors. In addition, the manually collected data is often no longer up-to-date after a short time. Traditional approaches are thus labor-intensive and not scalable.

### SUMMARY

According to a first aspect, the disclosure provides a system comprising circuitry configured to perform a vision-based registration task, the circuitry being coupled with an event-based vision sensor and being configured to be adaptive to inference quality derived from output of the event-based vision sensor and/or to be adaptive to consistency of a task output of the vision-based registration task.

According to a further aspect, the disclosure provides an EVS-based sensing subsystem comprising circuitry configured to perform a vision-based registration task, the subsystem comprising an event-based vision sensor and circuitry configured to output an inference quality metric to a processor of a vision-based registration task system.

According to a further aspect, the disclosure provides a computer-implemented method for performing a vision-based registration task, the method comprising acquiring output of an event-based vision sensor and adapting a vision-based registration task system to inference quality derived from the output of the event-based vision sensor and/or to a task output of the vision-based registration task performed by the vision-based registration task system.

According to a still further aspect, the disclosure provides a program comprising instructions, the instructions being configured to, when operated by a processor, perform the method mentioned above.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 shows an example of warehouse inventory;

FIG. 2a schematically shows an embodiment of an actuator-based optical registration system with EVS-based sensing subsystem;

FIG. 2b schematically shows an embodiment of an actuator-based optical registration system with EVS-based sensing subsystem comprising a conventional camera;

FIG. 3 shows a flow chart of a process of tag detection performed in an actuator-based optical registration system with EVS-based sensing subsystem;

FIGS. 4a and 4b show a possible implementation of the image quality metric that makes sure that the reconstructed image is contrastful;

FIG. 5 shows, as an example, a sharp image (top left image) and a corresponding presence of high frequency components in its Fourier transformation (top right image), as well as a blurry image (bottom left image) and a corresponding small magnitude of values in Fourier domain (bottom right image);

FIG. 6a schematically shows a data stream as obtained from an EVS sensor.

FIG. 6b shows an example of accumulating events obtained from an EVS sensor in channels;

FIG. 6c shows an example of time bin interpolation of events obtained from an EVS sensor;

FIG. 6d shows an example of splitting events obtained from an EVS sensor along polarity dimension.

FIG. 7 shows a flow chart of a process of tag detection with tag presence trigger performed in an actuator-based optical registration system with EVS-based sensing subsystem;

FIG. 8 shows a flow chart of a process of tag detection with detection and localization of a tag in an actuator-based optical registration system with EVS-based sensing subsystem;

FIG. 9 shows the actuator-based optical registration system with EVS-based sensing subsystem of FIG. 2 employed in an item registration task involving a conveyor belt;

FIG. 10 schematically shows an embodiment of an actuator-based optical registration system with EVS-based sensing subsystem implemented as a scanning drone;

FIG. 11 shows the actuator-based optical registration system with EVS-based sensing subsystem of FIG. 4 employed in a warehouse scenario; and

FIG. 12 shows the actuator-based optical registration system with EVS-based sensing subsystem of FIG. 2 employed in high-speed waste sorting.

### DETAILED DESCRIPTION OF EMBODIMENTS

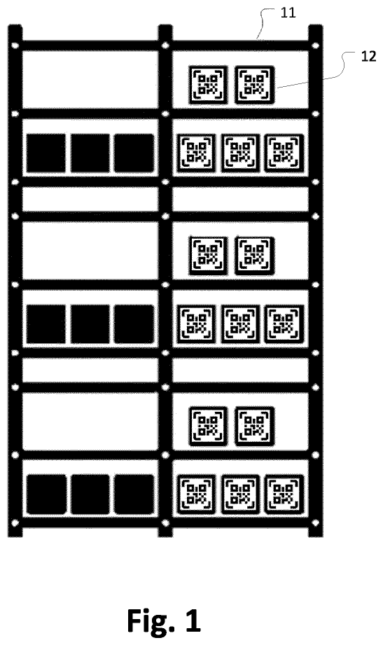

Before a detailed description of the embodiments under reference of FIG. 1 to FIG. 12, general explanations are made.

The embodiments disclose a system comprising circuitry configured to perform a vision-based registration task, the circuitry being coupled with an event-based vision sensor and being configured to be adaptive to inference quality derived from output of the event-based vision sensor and/or to be adaptive to consistency of a task output of the vision-based registration task.

The vision-based registration task may for example comprise scanning an item tag, an object classification or registration, high-speed item counting, high-speed waste sorting, item defect monitoring, or an extension of any of the above, hereinafter summarized as “vision-based registration task”.

Employing an actuator-based optical registration system with EVS-based sensing subsystem may for example result in that the vision-based registration task being executed in a high-speed fashion.

### Self-Adapting to Inference Quality and Confidence Metric of the Classified Objects.

Circuitry may include a processor. The processor may for example be a processor specialized for a specific task such as a tensor processing unit, an image signal processor, or a Field Programmable Gate Array, but it is not limited to these types of processors. Data processing may for example be performed by a processing unit of a sensing subsystem or by processing unit which s incorporated in an existing processing pipeline of an actuator's system. The circuitry or processor may also be configured to implement a neural network, such as a CNN or DNN, or the like.

Circuitry may include a memory, a storage, input means, output means light emitting diode, etc., loudspeakers, etc., an interface, etc., as it is generally known for electronic devices. Moreover, it may include sensors for sensing still image or video image data, for sensing a fingerprint, for sensing environmental parameters, etc.

The event-based vision sensor may for example be configured to observe a scene in which the vision-based registration task is to be performed.

The output of the sensor subsystem may for example be used to any combination of these applications: perform object registration, perform obstacle detection and avoidance, provide feedback to an actuator control loop.

An advantage of the system over deploying a sensing unit with conventional imaging sensors which are decoupled from actuator control may be the ability to find the state in which the whole system operates optimally with regard to a factor to be optimized, e.g. efficiency or throughput.

The circuitry may for example be configured to determine a quality metric from the output of the event-based vision sensor, the quality metric being used in a feedback loop to control an actuator and thus affect the quality of what is being sensed by the event-based vision sensor.

Quality metric may be anything that describes quality.

This motion generated by the actuator may affect if and how well the vision-based registration task can be performed and as such may impact, e.g. a classification certainty.

According to embodiments of the system, the system itself or an object can be moved in its relative position to the system by an actuator which gets control input based on the inference quality derived from output of the event-based vision sensor and/or the consistency of the task output.

The object may for example be moved on a conveyor belt which gets control input based on the inference quality derived from output of the event-based vision sensor and/or the consistency of the task output.

The actuator-based optical registration system may comprise an EVS-based sensing subsystem which comprises the event-based vision sensor.

The EVS-based sensing subsystem may comprise circuitry for perform at least parts of the vision-based registration task. The circuitry may for example comprise a processing unit which contains a processor specialized for a specific task such as a tensor processing unit, an image signal processor, or a Field Programmable Gate Array. The EVS-based sensing subsystem may also comprise circuitry such as a central processing unit that is assisted by a graphics processing unit and random access memory.

The system may be moved by an actuator, or an object may be moved in its relative position to the system by an actuator, the actuator getting control input based on the inference quality derived from output of the event-based vision sensor and/or the consistency of the task output.

The system may comprise an EVS-based sensing subsystem which comprises the event-based vision sensor, and wherein the EVS-based sensor subsystem uses events measured by EVS sensor to reconstruct item tags and/or navigational cues.

The system may comprise an EVS-based sensing subsystem which comprises the event-based vision sensor, and wherein the EVS-based sensor subsystem is configured to output an inference quality metric.

The inference quality may for example be derived from either image-based quality metrics or tag-based.

The system may comprise a conveyor belt which is coupled to an EVS-based sensing subsystem, the movement of the conveyor belt being adaptive to inference quality derived from output of the event-based vision sensor and/or to consistency of a task output.

For example, an embodiment foresees the installation of an actuator-based optical registration system with EVS-based sensing subsystem on a conveyor belt for recycling plant high-speed waste sorting. Recyclable waste needs to be sorted, such as glass, plastics, parts containing metal etc. This may be done either manually or with image-based vision systems using conventional cameras, and thus is a slow or tedious process.

The system may comprise an EVS-based sensing subsystem which is implemented onboard a scanning drone or robot, the movement of the scanning drone or robot being adaptive to inference quality derived from output of the event-based vision sensor and/or to consistency of a task output.

Using an EVS-based sensing subsystem may increase robustness of visual based localization methods. Thus, an automated robotic system can fulfill the task faster and safer, which are important parts when scaling up to the immense number of items to be registered/handled in warehouse applications. For power limitations, an autonomous system can increase the number of tasks fulfilled before its battery depletes, hence saving cost and time. The high degree of automation opens up the possibility of use during idle times. The solution can for example be used when no one is left in the warehouse. Already established processes and workflows remain untouched.

The item tags may be selected from barcodes, QR codes and April tags, and the vision-based registration task may for example comprise a process of tag detection.

The circuitry may be configured to transform an event representation of events obtained from the event-based vision sensor.

The circuitry may further be configured to perform image reconstruction based on an event stream obtained by the event-based vision sensor.

Still further, the circuitry may be configured to perform a specified task on reconstructed images to obtain a task output.

In other embodiments, the circuitry is configured to operate directly on the event stream without reconstructing images from the event stream. This may for example be achieved using spiking neural networks (SNNs).

Performing specified task may for example comprise performing a vision-based registration task, such as decoding an image tag, object classification or 3D registration. This can be solved using existing and established algorithms directly on reconstructed images or in direct event input. The task output 33 can for example be an image tag, QR code, an object label or a point cloud that has been detected when performing the task. For example, a neural network-based algorithm can be used to scan the QR code from contrast change information in the reconstructed images.

The circuitry may be configured to perform inference of image quality is performed based on reconstructed images to obtain an image quality metric.

The image quality metric can for example be a no-reference metric, meaning the reconstructed image will not be compared to a ground-truth or absolute intensity image. The metric can for example be used to detect e.g. the presence of tags or the quality of a reconstructed image.

The circuitry may be configured to perform a consistency check on the task output to obtain a consistence metric

The consistence metric may be anything that describes consistency of the task output. The consistence metric may for example be a confidence value, e.g. a code confidence.

The circuitry may be configured to perform a control loop based on an image quality metric and/or a consistence metric.

EVS-based feedback to a navigation control loop may for example be beneficial as the system does not have to stop in order to take a blur-free picture.

For example, the process may implement a control loop in which an image quality metric is used by the vision-based registration task system in a feedback loop to control an actuator and thus to affect the quality of what is being sensed in the scene. For example, the control loop may act on an actuator of an external or internal system and try to optimize to increase the image quality metric.

The circuitry may be configured to deduce the possibility of the current frame containing an image tag, and/or the circuitry is configured to localize a tag.

Non-existence of a tag is information which can be fed into the control loop to e.g. increase movement speed of the e.g. conveyor belt as currently no objects are in the field of view of the camera subsystem.

Detection and localization of a tag can be but does not necessarily have to be solved using a neural network.

The embodiments also disclose an EVS-based sensing subsystem comprising circuitry configured to perform a vision-based registration task, the subsystem comprising an event-based vision sensor and circuitry configured to output an inference quality metric to a processor of a vision-based registration task system.

The embodiments also disclose a computer-implemented method for performing a vision-based registration task, the method comprising acquiring output of an event-based vision sensor and adapting a vision-based registration task system to inference quality derived from the output of the event-based vision sensor and/or to a task output of the vision-based registration task performed by the vision-based registration task system. The method may comprise all process described herein.

The embodiments also disclose a program comprising instructions, the instructions being configured to, when operated by a processor, perform the methods described above.

Assuming the system is coupled with the actuator that either moves the sensing unit or the object of interest, that would allow to optimize for the optimal movement speed (derived from an image quality metric) where e.g. image tags can still be detected and recognized but also improves throughput compared to a normal sensor which is limited in this domain. Usually objects on a conveyor belt move with a fixed speed, slow enough to ensure there is no motion blur.

### Event-Based Vision Sensors (EVS)

Conventional cameras such as those found in smartphones function by regularly acquiring, at a specific frame rate, full images of the whole scene, which is done by exposing the pixels of the image all at the same time. With this technique, however, a moving object cannot be detected until all the pixels have been analyzed by the on-board computer. With the frame-based method used by conventional cameras, the entire image is output at certain intervals determined by the frame rate. Conventional cameras have low frames rates and need good light conditions. Visual systems using conventional cameras or depth sensors are accurate (up to 5 cm), but are not fast. Radiofrequency based localization techniques, on the other hand, suffer from low accuracy (10-30 cm).

With conventional cameras, the faster the sensor or the object is being moved, the lower the SNR (signal-to-noise ratio) in the image acquired. Movement during the exposure period leads to motion blur, obfuscating e.g. the tag to be detected and recognized.

Event-based Vision Sensors (hereafter also referred to as EVS sensors or simply EVS), to the contrary, utilize an event-based method that asynchronously detects pixel luminance changes and outputs data with pixel position and time information, thereby enabling high-speed, low latency data output. That is, EVS sensors register changes in contrast with very high temporal resolution. EVS sensors have low latency (in the order of microseconds), and high dynamic range. They provide a much higher “framerate” than traditional vision systems. They thus are more robust to motion blur in adverse lighting scenarios.

EVS sensors respond to brightness changes in the scene asynchronously and independently for every pixel. Pixels that detect no brightness change remain silent. When the brightness change of a pixel exceeds a threshold, the camera sends an event, which is transmitted from the chip with the location, the time, and the polarity of the change. The events are transmitted from the pixel array out of the camera using a shared digital output bus, typically by using address-event representation (AER) readout.

As an EVS sensor records changes in intensity (temporal contrast steps), no movement yields a rather low SNR, as information is difficult to disentangle from background noise. The faster the object or camera moves, the higher the SNR, until other limits (e.g. bandwidth limitations).

Additionally, the SNR of the EVS is also dependent on the underlying texture of the area of interest. Flat (white) areas generate almost no events, irrespective of movement while contrast-rich areas generate a lot of events. Hence, the EVS is well suited for item tag registration tasks.

The output of an EVS is a variable data stream of digital events, with each event representing a change of brightness of predefined magnitude at a pixel at a particular time. In contrast to conventional cameras, EVS sensors generate a sparse stream of events so that only a tiny fraction of all pixels in the image needs to be processed by the on-board computer, thus speeding up the computations considerably.

### Inventory Registration

FIG. 1 shows an example of warehouse inventory. An inventory item 12 of the warehouse is positioned within a pallet rack 11. The inventory item 12 is provided with a visual code (such as a QR code or barcode). Warehouses usually maintain a large number of such pallet racks 11 for storing inventory.

According to the embodiments described below in more detail, automated drones are deployed to take over warehouse inventory applications such as item search, inventory audit, object classification/registration, cycle counting, and stock taking, and automated quality assurance. The drone's task is to fly over the shelves, record labels and other relevant location and object data, and process this information automatically. The drones that are used for warehouse inventory applications are equipped with cameras and fly by all shelves at different heights throughout the warehouse. The drone usually stops briefly at one item position to take a picture of the QR code to register the produce. Automated drones may for example take over such warehouse inventory applications during off-hours.

Other applications where drones may be applied in a similar manner are QR Code or Quality registration on conveyor belts in manufacturing processes, drone inspections of fields in farming, spare parts delivery, or object classification on conveyor belts for sorting, such as item classification for sorting recyclable waste in recycling.

Drones may apply conventional cameras and visual SLAM techniques (Simultaneous Localization and Mapping) to accomplish the above tasks. While Visual SLAM is very accurate, wide aisles are required and the autonomous system usually only flies during off-hours to avoid accidents with workers or other obstacles. The use of SLAM algorithms enables drones to first map the environment and simultaneously determine their own position. This allows the drone to navigate through an unknown terrain without GPS or Wi-Fi.

Actuator-Based Optical Registration System with EVS-Based Sensing Subsystem

The embodiments described in more detail propose to couple an actuator-based optical registration system with an event-based vision sensor (EVS). In particular, the embodiments provide a subsystem, which is comprised of an event-based vision sensor (EVS) connected to a processing system running an algorithm. This subsystem is attached to any existing actuator based optical registration system. The embodiments thus provide a system for automated high-speed item registration.

The embodiments describe execution of a vision-based object registration task in high-speed fashion, where the system itself or the object can be moved in its relative position to the system by an actuator, which gets its control input based on the quality or confidence of performing the registration task.

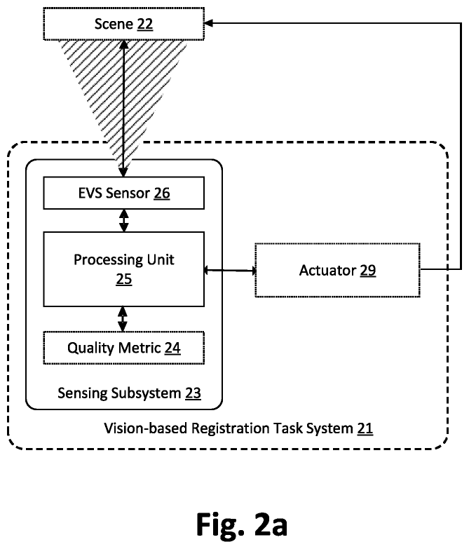

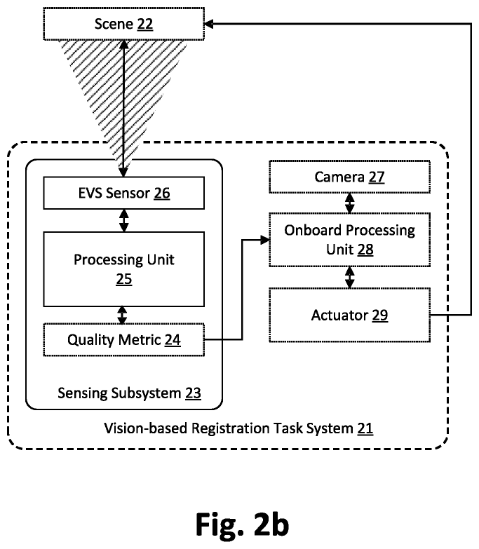

FIG. 2a schematically shows an embodiment of an actuator-based optical registration system with EVS-based sensing subsystem. A vision-based registration task system 21 is configured to perform a registration task involving inventory items in a scene 22. The vision-based registration task system 21 further comprises a sensing subsystem 23 comprising an EVS Sensor 26 that is configured to observe the scene 22. The sensing subsystem 23 comprises a processing unit 25 that communicates with the EVS Sensor 26. The processing unit 25 may contain a processor specialized for a specific task such as a tensor processing unit (TPU), an image signal processor (ISP), or a Field Programmable Gate Array (FPGA), but it is not limited to these types of processors. According to an alternative embodiment, the sensing subsystem comprises a central processing unit (CPU) that is assisted by a graphics processing unit (GPU) and random-access memory (RAM).

The sensing subsystem 23 uses the events measured by EVS sensor 26 to reconstruct item tags and any navigational cues, while simultaneously outputting an inference quality metric 24. That is, by means of the EVS sensor 26, the processing unit 25 of the sensing subsystem 23 is capable of outputting information related to e.g. an item tag (e.g., QR code, April tag) to be scanned, an object classification or registration (3D scan), high-speed item counting, item defect monitoring, or an extension of any of the above, hereinafter summarized as “vision-based registration task”. Based on the information obtained from the EVS sensor 26, the processing unit 25 of the sensing subsystem 23 determines a quality metric 24. This quality metric 24 is used by the vision-based registration task system 21 in a feedback loop to control actuators 29 (e.g. motors) and thus affect the quality of what is being sensed in the scene 22. The sensing subsystem 23 is configured to output information related to scanning/inference quality or confidence metric and navigational cues such as position, pose of the system and any obstacles along the trajectory.

The output of the sensor subsystem may for example be used to any combination of these applications: perform object registration, perform obstacle detection and avoidance, provide feedback to the actuator control loop.

In the embodiment of FIG. 2a, the event-based vision sensor 26 operates according to the EVS principle described above. It should however be noted that the event-based vision sensor 26 as used in the embodiments below may also be a hybrid sensor comprising conventional pixels (which output e.g. RGB or gray-level) and pixels which operate asynchronously according to the EVS principle described above. Such a hybrid sensor may operate according to the principle of temporal multiplexing (e.g. some sensors have pixels which could change the operation mode and capture events and intensity alternatively) or according to the principle of spatial multiplexing (some sensors have both EVS and conventional pixels, such that it can capture both kinds of information simultaneously).

In order to solve a vision-based registration task, such as scanning an item tag (e.g. QR code), the events are typically pre-processed first as the EVS senses changes in intensity from reflectance of objects in logarithmic scale. There are rule-based algorithms and learned mappings (neural network-based methods) well described in literature (see, e.g., Zelin Zhang et al., “Image Reconstruction from Events. Why learn it?”, Computer Science ArXiv, 2021; C. Scheerlinck et al., “Fast Image Reconstruction with an Event Camera”, IEEE Winter Conference on Applications of Computer Vision, 2020). Most of these techniques target to reconstruct the image from events before detecting and parsing the tag information. In the embodiments presented, a neural-network-based approach will be used, as they are proven to be fast and accurate. The image reconstruction and tag decoding steps can be preceded by a fast tag localization algorithm working on events directly.

The inference quality can be derived from either image-based quality metrics (e.g. PSNR) or tag-based (e.g. cross-referencing if tag was registered properly and exists in a database). While the image quality does not fall below a specified threshold, control feedback to the actuator system can be given to e.g. increase the moving speed of the actuator (conveyor belt, robot). Note that any movement caused by the actuator in the system (moving reference system) against the scene containing the tag (fixed reference system) will impact if and how well the tag can be perceived by the sensor, thus affecting the classification certainty or inference quality respectively.

Navigational cues can be inferred using a NN-based algorithm to detect obstacles with very low latency. For all NN-based algorithms there is no limitation to dedicated processing units, but it might prove helpful for inference speed. The events will be transformed into a convenient representation as inputs to the neural network. The output here can be bounding box coordinates which includes the position and size of objects detected.

In the example of FIG. 2a, data processing is performed by the processing unit 25 of the sensing subsystem 23 and the actuation/control output is directly provided by the processing unit 25 of the sensing subsystem 23.

In alternative embodiments, the data processing can also be incorporated in an existing processing pipeline of the actuator's system (e.g. into onboard processing unit 28), as shown in FIG. 2b, if enough compute resources are available.

Further, a conventional camera (e.g. RGB or gray-level) may be used in parallel to an EVS-based sensor within an EVS-based sensing subsystem, as shown in FIG. 2b.

FIG. 2b schematically shows an embodiment of an actuator-based optical registration system with EVS-based sensing subsystem comprising an onboard processing unit and a conventional camera. The vision-based registration task system 21 of FIG. 2b differs from the embodiment in FIG. 2a in that it comprises an onboard processing unit 28 which communicates with a conventional camera 27 and with actuators/motors 29. The sensing subsystem 23 communicates with the onboard processing unit 28 of the vision-based registration task system 21. In the embodiment of FIG. 2b, data processing is performed by the onboard processing unit 28 of the actuator-based optical registration system and the actuation/control output is provided by the onboard processing unit 28 of the actuator-based optical registration system.

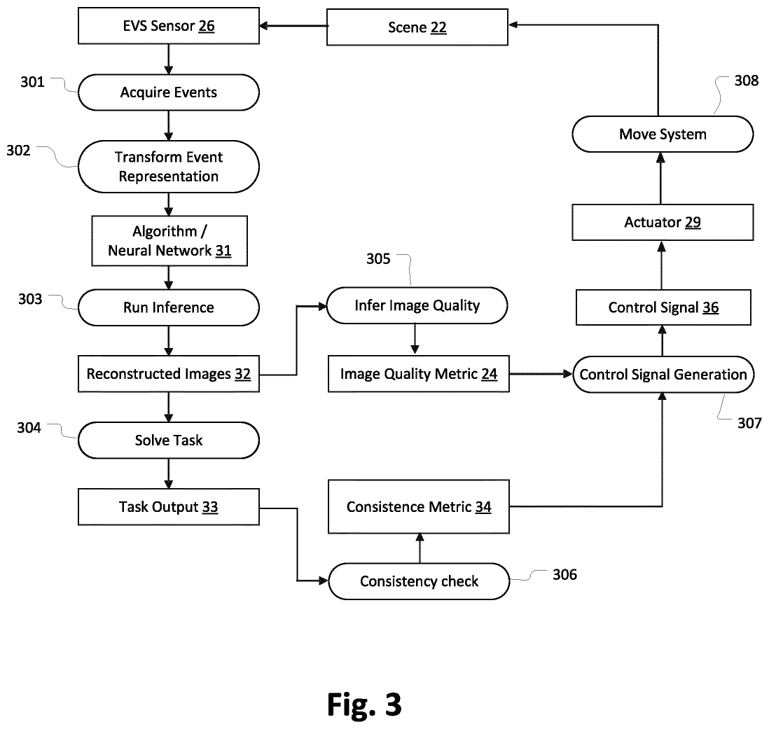

It should also be noted that scene 22 in FIGS. 2a, 2b and 3 refers to the world (fixed coordinate system) which also contains the tags to be scanned, while the vision-based registration task system 21 depicts a moving reference system that can be changed in location and pose by the actuator. This motion affects if and how well the tag can be perceived and as such impacts the classification certainty of the tag.

Alternatively, the camera system can be firmly mounted (in a fixed coordinate system) and the items containing the tags can be moved in a moving reference system relative to the fixed coordinate system of the camera system. This is described in more detail with regard to the conveyor belt system with EVS-based sensing subsystem described below.

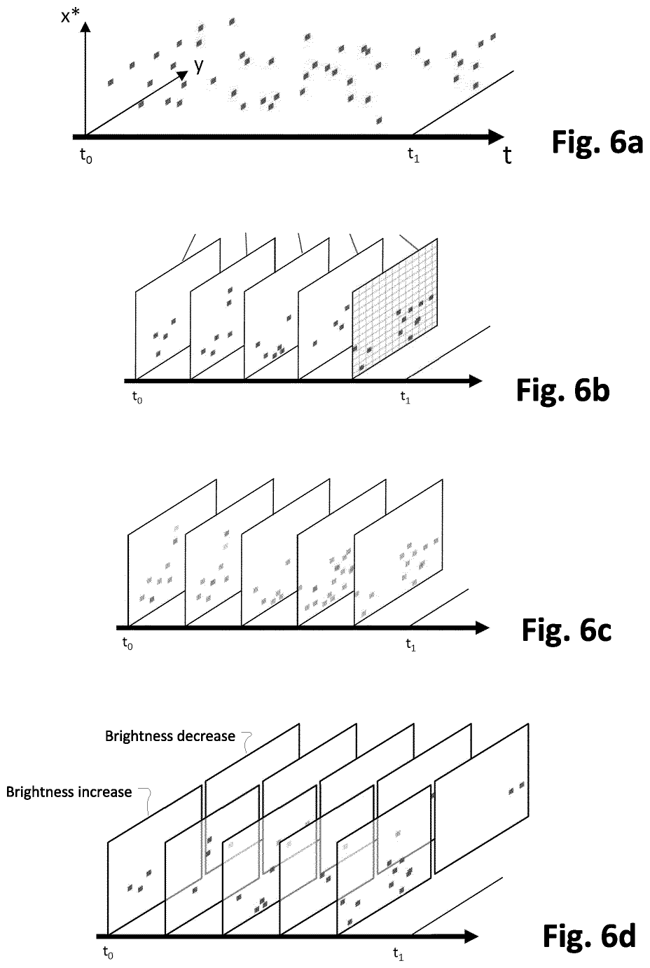

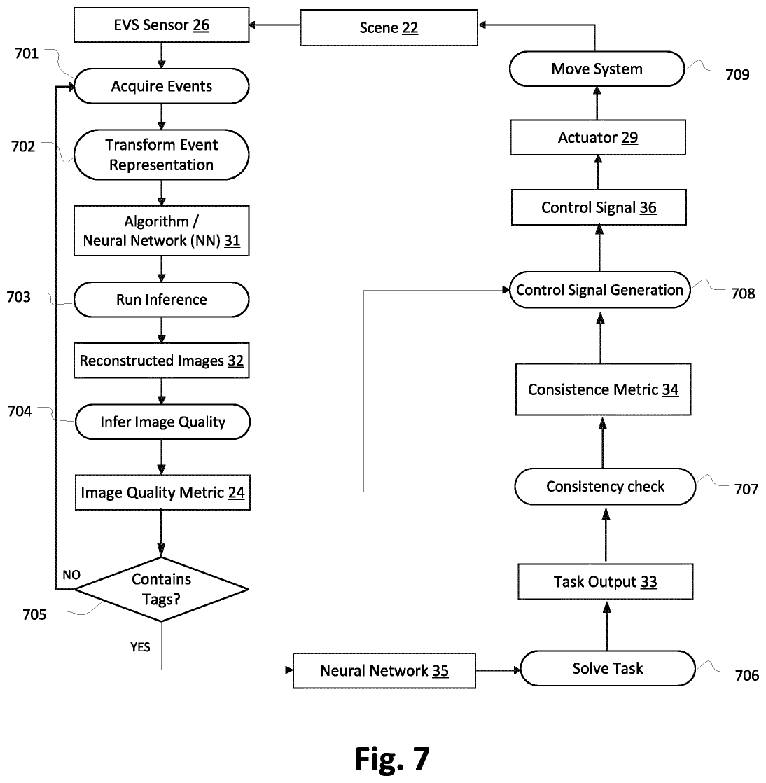

FIG. 3 shows a flow chart of a process of tag detection performed in an actuator-based optical registration system with EVS-based sensing subsystem. At 301, events are acquired from EVS sensor 26. At 302, the event representation of the events obtained from EVS sensor 26 is transformed. One possible representation of the asynchronous and continuous stream of event data is to transform it into a 2D frame using the pixel location of each event and its timestamp as the value of the pixel. Another option is to transform incoming events in a certain time window or a fixed number of events into a 3D volume. The x- and y-dimension represent the location of the event, while the 3^{rd} axis represents the arrival time of the event. This discretized 3D volume is also called a voxel grid or event grid. This representation transformation is adapted to the required input shape of the subsequent algorithm or neural network architecture. It should however be noted that transforming the event data is optional. For example, it may not be needed if for e.g. a Spiking Neural Network is used. Further details concerning this transformation of the event stream are described with regard to FIGS. 6a-d below.

The transformed event representation as obtained in 302 is fed to an algorithm or neural network 31. At 303, the algorithm or neural network 31 runs an inference on the transformed event representation to obtain reconstructed images 32. For example, one approach is to first reconstruct an intensity image from the temporal contrast changes (events), which can be done algorithmically by integrating the intensity changes over time or by employing a CNN (Convolutional Neural Network)-based approach. Depending on the event representation, running inference on one event input can reconstruct multiple subsequent images. For example, a neural network-based algorithm can be used to reconstruct images.

At 304, a specified task is performed on the reconstructed images 32 to obtain a task output 33. Performing specified task may for example comprise performing a vision-based registration task, such as decoding an image tag, object classification or 3D registration. This can be solved using existing and established algorithms directly on reconstructed images or in direct event input. The task output 33 can for example be an image tag, QR code, an object label or a point cloud that has been detected when performing the task. For example, a neural network-based algorithm can be used to scan the QR code from contrast change information in the reconstructed images.

At 305, inference of image quality is performed based on the reconstructed images 32 to obtain an image quality metric 24. The image quality metric can for example be a no-reference metric, meaning the reconstructed image 32 will not be compared to a ground-truth or absolute intensity image (as a conventional imaging sensor is not required for this setup). The metric can then be used to detect e.g. the presence of tags or the quality (contrast) of a reconstructed image 32.

At 306, a consistency check is performed on the task output 33 to obtain a consistence metric 34 (e.g. a code confidence). Given a certain confidence in the presence of an item tag/code from the image quality metric (by trying to detect a code in the current frame, where frame refers to events transformed into a representation suitable as input to the subsequent algorithm) may yield additional information: (Non-)Existence of detected code in a potential database, or a failed code detection. The consistence metric 34 can be fed along with the image quality metric 24 to the control loop to determine whether an actuator 29 should slow down object movement or increase object movement.

At 307, a control signal 36 is generated based on the consistence metric 34 and the image quality metric 24 and the control signal 36 is fed to an actuator 29 of an external or internal system (e.g. a conveyor belt or robot motors). At 308, the actuator 29 moves the system based on the control signal 36 received from control signal generation 307 to influence the scene. This process implements a control loop (feedback loop) in which the image quality metric 24 is used by the vision-based registration task system 21 in a feedback loop to control actuator 29 and thus to affect the quality of what is being sensed in the scene 22. For example, the control loop acting on the actuator 29 of the external or internal system will try to optimize to increase image quality metric 24. E.g., if a potential target (code/tag) is not detected, a conveyor belt is moved faster as there are possibly no events in the field of view of the camera system. Another policy can be trying to increase speed while image quality can be maintained and code is successfully read, to dynamically optimize for throughput of a vision-based registration task.

In the embodiment of FIG. 3, the algorithm or neural network 31 runs an inference on the event representation to produce reconstructed images 32. This process is, however, optional. It is conceivably possible to solve the task (304 in FIG. 3), e.g. detecting and recognizing a tag, directly from events without reconstructing intensity images.

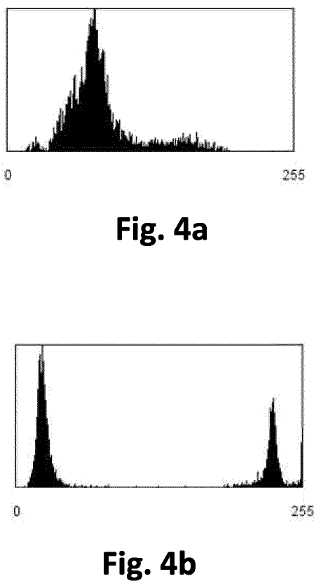

FIGS. 4a and 4b show a possible implementation of the image quality metric that makes sure that the reconstructed image is contrastful (as barcodes, QR codes, April tags, etc. are a combination of black and white geometries). In this example, inferring image quality at 305 comprises determining a histogram of image intensities. The image quality metric 24 is represented by the histogram of image intensities. The abscissa of the histogram shows intensity bins from 0 to 255, whereas the ordinate shows the accumulated number of pixel intensities for each respective intensity bin. The histogram of image intensities shows two intensity peaks around dark and bright values for presence of codes and a rather centered and narrow distribution for a flat and contrastless image. FIG. 4a shows a rather flat image without a QR code. FIG. 4b shows a contrastful image with presence of a code tag. The detection of QR-codes in digital images may thus be based on histogram similarity. For example, an algorithmic approach is to compute the RMS contrast, which comprises looking at the standard deviation of pixel intensities of the histogram (which is low for FIG. 4a and high for FIG. 4b).

Another example of determining an image quality metric is to look at the 2D frequency domain of the pixel intensities. An image containing a code/image tag will have distinct frequency peaks within the frequency domain.

Another option for a no-reference image quality metric is to evaluate the reconstructed image in the frequency domain by applying a Fourier transformation on the reconstructed images. This allows to make statements about sharpness of an image by looking at the magnitude of the values. A lack of high-frequency component means there are no fast changes in image intensities along gradients, thus no sharp transitions (which are preferred for tag/code detection tasks).

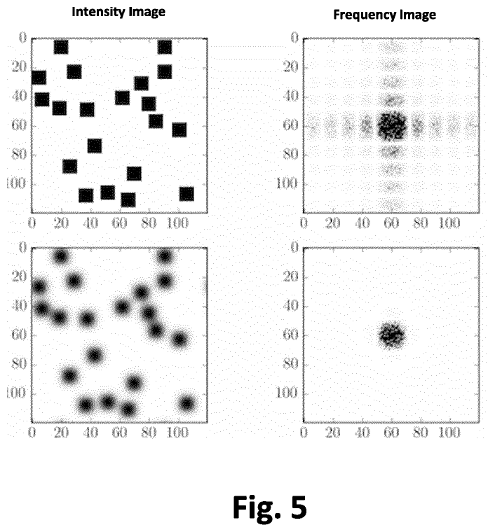

FIG. 5 shows, as an example, a sharp image (top left image) and a corresponding presence of high frequency components in its Fourier transformation (top right image), as well as a blurry image (bottom left image) and a corresponding small magnitude of values in Fourier domain (bottom right image).

Further options for determining a no-reference image quality metric can include adding a conventional image sensor which records images at a lower frequency but provides a reference for other image quality metrics such as Structural Similarity Index Measure (SSIM) or Peak Signal to Noise Ratio (PSNR), or more human perceptual metrics such as VGG Loss (VGG=Visual Geometry Group) or LPIPS Loss (LPIPS=Learned Perceptual Image Patch Similarity).

FIGS. 6a-d show examples of an event representation transformation as it may be performed at 302 of FIG. 3. To handle the sparse and continuous event data stream obtained from the EVS sensor the sensor raw data is transformed. One possibility is to use a dedicated representation called voxel grids (or event grids) which represent events in a fixed grid that can be input into standard networks. Voxel grids are 3D volumes, where events are split to a specific layer/channel according to their timestamp. Voxel grids (event grids) may be created with a combination of the following methods. A predefined number or fixed time windows of events are defined, and, based on these time windows, time is split into channels (time bins). Then, event pixel values are interpolated according to exact arrival timestamp between two channels. Optionally or alternatively, there is the possibility to split event values along a polarity dimension.

FIG. 6a schematically shows a data stream as obtained from an EVS sensor. Multiple individual events captured between times to and ti by the sensor are plotted in a three-dimensional diagram. The abscissa of the three-dimensional diagram shows the time at which an event was captured. The ordinate x* and the depth-axis y show the pixel position at which the event was captured.

FIG. 6b shows an example of accumulating events obtained from an EVS sensor in channels. A predefined number or fixed time windows of events is defined. Time is thus split into a predefined number of channels (time bins), here for example 5 channels.

FIG. 6c shows an example of time bin interpolation of events obtained from an EVS sensor. Event pixel values are interpolated according to their exact arrival timestamp between two channels.

FIG. 6d shows an example of splitting events obtained from an EVS sensor along a polarity dimension. The events obtained from the sensors event stream have different polarities. This polarity may for example be expressed as a 1-bit polarity p of the brightness change decoding brightness increase, or brightness decrease. In the example of FIG. 6d all events with positive polarity (brightness increase) are grouped together, and all events with negative polarity (brightness decrease) are grouped together.

FIG. 7 shows a flow chart of a process of tag detection with tag presence trigger performed in an actuator-based optical registration system with EVS-based sensing subsystem. Steps 701, 702, 703 and 704 in FIG. 7 correspond to steps 301, 302, 303 and 305 in FIG. 3, respectively, and, therefore, will not be described in detail for sake of brevity. Similarly, steps 706, 707, 708 and 709 in FIG. 7 correspond to steps 304, 306, 307 and 308 in FIG. 3, respectively, and are therefore not described again. The process illustrated in FIG. 7, however, deviates from the process illustrated in FIG. 3 in that it includes the additional step 705 of deducing the possibility of the current frame containing an image tag. At 704, a similar approach as at 305 in FIG. 3 can be applied to derive an image quality metric 24 by performing inference of image quality based on the reconstructed images 32. At 705, it is determined, based on the image quality metric 24 obtained in 704, whether the reconstructed images contain tags or do not contain tags. The rest of the pipeline is only triggered by presence of such a tag. If it is determined at 705 that the image contains a tag, then the process continues with solving a task 706 by means of a neural network 35. On the other hand, if it is determined at 705 that the image contains no tag, the process turns back to step 701. That is, non-existence of a tag is information which can be fed into the control loop to e.g. increase movement speed of the e.g. conveyor belt as currently no objects are in the field of view of the camera subsystem.

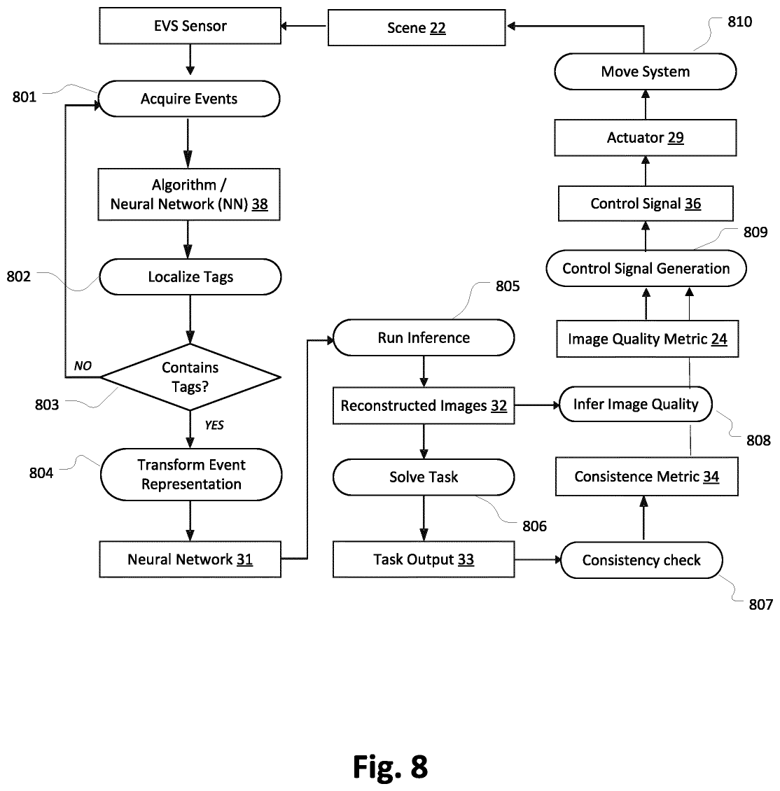

FIG. 8 shows a flow chart of a process of tag detection with detection and localization of a tag in an actuator-based optical registration system with EVS-based sensing subsystem. Steps 801, 804, 805, 806, 807, 808, 809 and 810 in FIG. 8 correspond to steps 301, 302, 303, 304, 305, 306, 307 and 308 in FIG. 3, respectively, and, therefore, will not be described in detail for sake of brevity. The process illustrated in FIG. 8, however, differs from the process illustrated in FIG. 3 in that it includes the additional step 802 following step 801. At 801, events are acquired from EVS sensor 26. The acquired events are fed to an algorithm or neural network 38. At 802, the algorithm or neural network 38 runs an inference on the acquired events to localize tags. If it is determined at 803 that a tag is present, the event representation of the events obtained from EVS sensor 26 is transformed at 804, similar to step 302 in FIG. 3. On the other hand, if it is determined at 803 that no tag is present, the process turns back to step 801. Detection and localization of a tag can be but does not necessarily have to be solved using a neural network.

Algorithmically, the detection of a barcode or item tag can comprise counting number of positive and negative events. If they exceed a certain threshold, the rest of the pipeline is triggered.

Another rule-based approach is to detect corners directly on the event stream. If a certain density of corners is detected in a cluster of events, it can be assumed a region with a potential item tag.

A spiking neural network is also a potential neural network-based approach, as it is designed to handle asynchronous data streams like events. It can be used to detect and localize code tags.

Conveyor Belt System with EVS-Based Sensing Subsystem

In the following it is described an embodiment that incorporates a conveyor belt-based system.

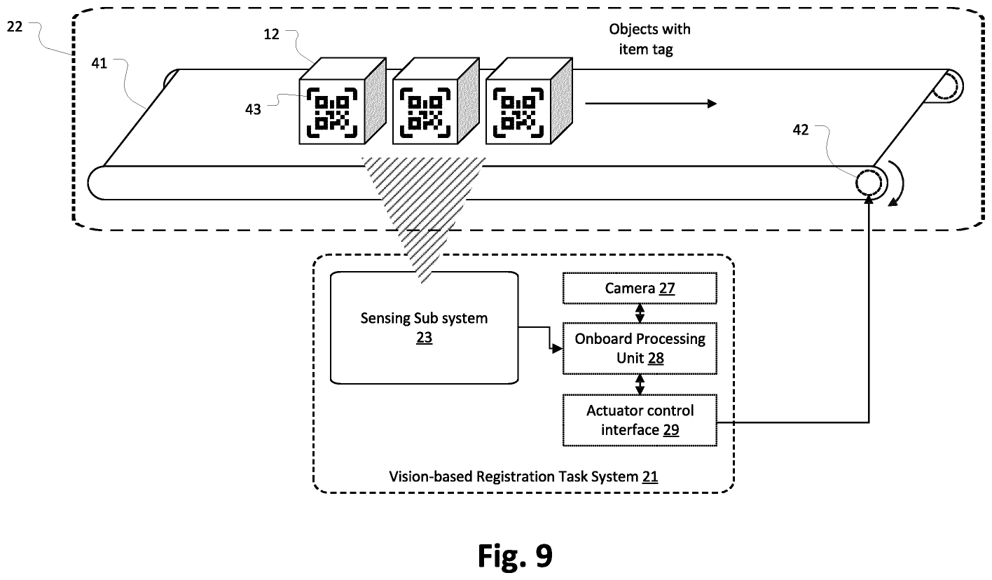

FIG. 9 shows the actuator-based optical registration system with EVS-based sensing subsystem of FIG. 2 employed in an item registration task involving a conveyor belt. A vision-based registration task system 21 (such as described in FIG. 2 above) is configured to perform an object classification task within a scene 22 comprising objects 12 with item tags 43 on a conveyor belt 41. The vision-based registration task system 21 comprises a sensing subsystem 23 with an EVS sensor that observes the scene 22. The sensing subsystem 23 communicates with an onboard processing unit 28 of the vision-based registration task system 21. The output of the sensing subsystem 23 is used by the vision-based registration task system 21 in a feedback loop to control (via an actuator control interface 29 of the vision-based registration task system 21) a motor 42 of the conveyor belt 41, and thus to affect the quality of what is being sensed by the vision-based registration task system 21 in the scene 22. Motor 42 drives the conveyor belt 41 and thus determines the speed with which the objects are moving on the conveyor belt 41.

For example, if the sensing subsystem 23 of the vision-based registration task system 21 determines that a fast and high-quality scan of an item tag 43 has been captured by an EVS sensor of the sensing subsystem 23, it can infer that the conveyor belt 41 may be moved faster without negatively affecting the image acquisition.

By providing the high-speed subsystem described above, the item tags 43 (such as barcodes or QR codes) can be scanned with much higher speed while eliminating the need of external light sources. The subsystem gives feedback on the quality of the scanned tag and if it was not successfully registered due to wear or defective label. This feedback can be passed to the actuator 32 of the main system, which allows for dynamic setting of the conveyor belt speed. While the scanned tag quality is determined to be sufficient, the speed can be increased and thus the throughput of the whole factory or warehouse.

It should be noted that the actuator-based optical registration system with EVS-based sensing subsystem of FIG. 2 may, in addition to the EVS sensor, also apply a conventional frame-based camera mounted on a rail with possible flash or external light source to improve the camera's SNR.

### EVS-Based Sensing Subsystem Onboard a Scanning Drone

Another embodiment features an EVS-based sensing subsystem onboard a scanning drone. With the techniques provided by the embodiments, drones can more easily accomplish indoor-navigation in warehouses.

An EVS-based sensing subsystem onboard a scanning drone may for example feature a forward-facing camera. The drone moves sideways from item to item in a multi-level shelf in big warehouses. With only a forward-facing camera, for each item, the drone needs to make a quick stop in order to ensure blur-free image of the scanned tag.

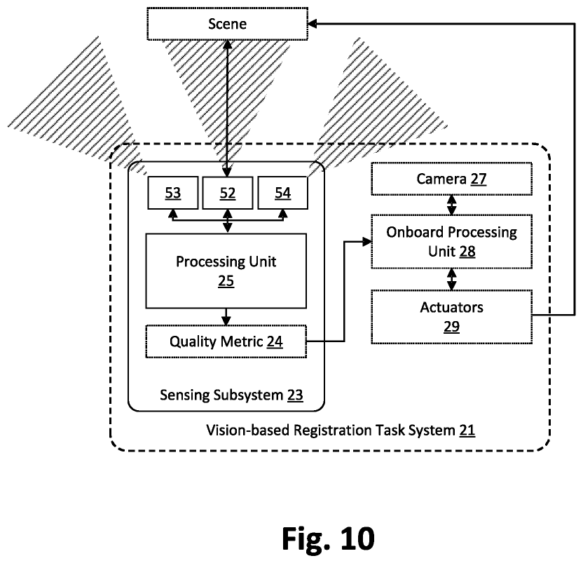

FIG. 10 schematically shows an embodiment of an actuator-based optical registration system with EVS-based sensing subsystem implemented as a scanning drone. The vision-based registration task system 21 of FIG. 10 is similar to that of FIG. 2. It is configured to perform a registration task involving inventory items in a scene 22. The vision-based registration task system 21 comprises an onboard processing unit 28 which communicates with a conventional camera 27 and with actuators 29. The vision-based registration task system 21 further comprises a sensing subsystem 23 that communicates with the onboard processing unit 28 of the vision-based registration task system 21. The sensing subsystem 23 is implemented onboard a scanning drone. The sensing subsystem 23 deploys three EVS sensors 52, 53, 54, one front-facing 52, and two sideway-facing 53, 54.

As in the embodiment of FIG. 2, the sensing subsystem 23 comprises a processing unit 25 that communicates with the EVS sensors 26. The sensor subsystem 23 uses the events measured by EVS sensors 26 to perform vision-based registration tasks as described in more detail with regard to FIG. 2 above. Based on the information obtained from the EVS sensors 26, the processing unit 25 of the sensing subsystem 23 determines a quality metric 24. This quality metric 24 is used by the vision-based registration task system 21 in a feedback loop to control actuators 29 and thus affect the quality of what is being sensed in the scene 22.

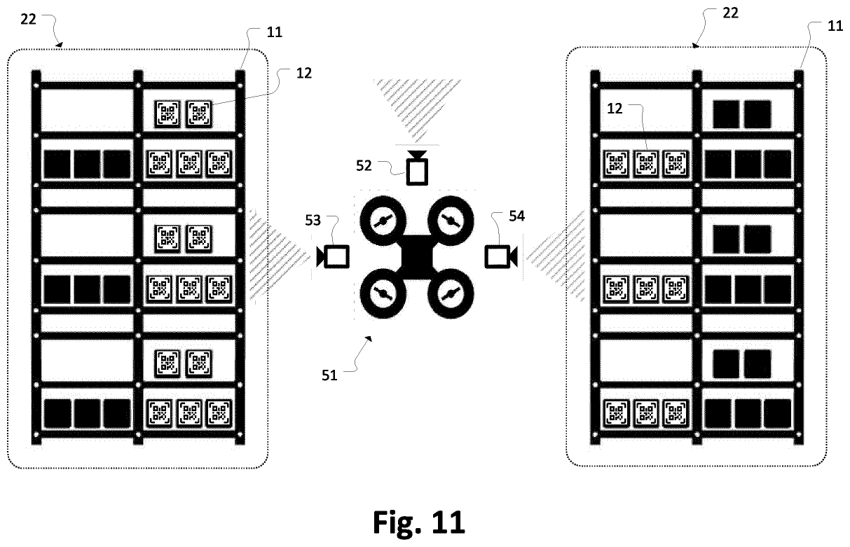

FIG. 11 shows the actuator-based optical registration system with EVS-based sensing subsystem of FIG. 10 employed in a warehouse scenario. A scene 22 comprises multiple inventory items 12 of a warehouse that are positioned within pallet racks 11. The inventory items 12 are provided with a visual codes (such as a QR codes or barcodes). An EVS-based sensing subsystem is implemented onboard a scanning drone 51. The scanning drone 51 features three EVS cameras, one front-facing camera 52, and two sideway-facing cameras 53, 54. The front-facing EVS camera 52 provides obstacle avoidance and additional high-speed navigational clues, allowing for a deployment of the drone during work hours and not only when the warehouse is empty. The sideway-facing EVS cameras are configured to continuously detect and scan item tags or QR codes without stopping the drone, as the event encode all motion information. By feeding back the image quality, for example, the flying speed of the drone 51 can be adjusted. The sensing subsystem (23 in FIG. 2) may thus allow for a much higher throughput of the drone 51, scanning more items 12 in shorter time, thus leading to less down-time due to need of recharging the batteries.

As shown in FIGS. 10 and 11, EVS sensors can be deployed to register all products while flying by the shelves in high speed. Using an EVS sensor, the drone does not have to keep a stable position while registering barcodes, as it would be the case with a conventional camera that suffers from motion blur. This allows for fast registration of items or tags (such as QR codes). Still further, EVS allows for detection of obstacles in trajectories. EVS sensors may in particular be used for autonomous registration of moving items by drones, where fast motions and challenging illumination conditions are ordinary. Drones need less space and less accurate motion planning to avoid obstacles. Still further, applying EVS sensors may result in that a drone needs to recharge less often so that it can finish its path quicker, which saves cost and power. The proposed autonomous system is less limited in range and flight time by the battery and their onboard vision systems to fulfill their task. That is, according to the embodiments, warehouse scanning coverage may be increased.

In the embodiments of FIGS. 10 and 11 above an EVS-based sensing subsystem is shown that is implemented onboard a scanning drone. It should, however, be noted that in alternative embodiments, the EVS-based sensing subsystem might as well be implemented on board of robots or the like.

### High-Speed Waste Sorting

Yet another embodiment foresees the installation of an actuator-based optical registration system with EVS-based sensing subsystem on a conveyor belt for recycling plant high-speed waste sorting. Recyclable waste needs to be sorted, such as glass, plastics, parts containing metal etc. This may be done either manually or with image-based vision systems using conventional cameras, and thus is a slow or tedious process.

Employing an actuator-based optical registration system with EVS-based sensing subsystem as described below in more detail results in high-speed waste sorting and is self-adapting to inference quality and confidence metric of the classified objects.

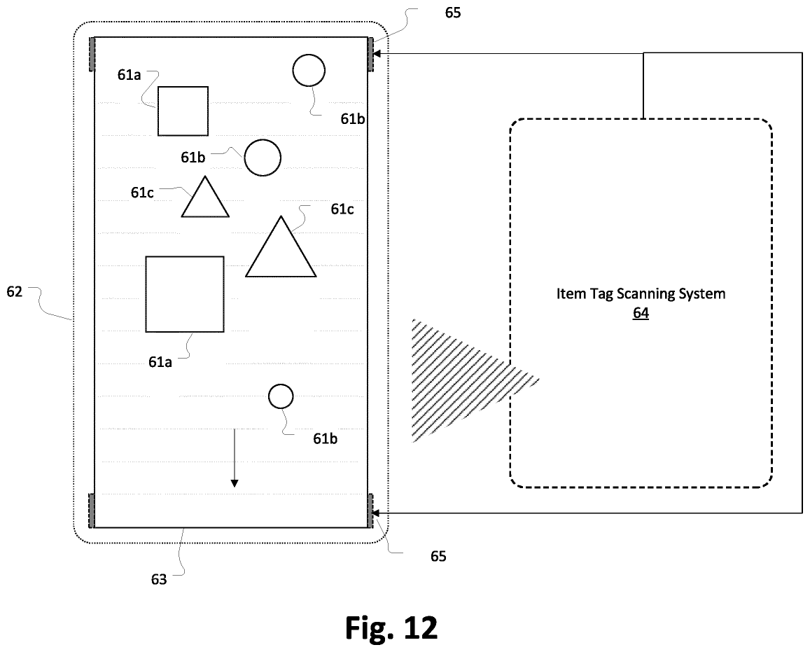

FIG. 12 shows the actuator-based optical registration system with EVS-based sensing subsystem of FIG. 2 employed in high-speed waste sorting.

A scene 62 comprises multiple waste items 61a, b, c that are positioned on a conveyor belt 63. The waste items 61a, b, c are of different type. Waste items 61a are of a first type, as symbolized by a square. Waste items 61b are of a second type, as symbolized by a circle. Waste items 61c are of a third type, as symbolized by a triangle. The waste items 61a, b, c may be of different size. An item tag scanning system 64 with an EVS-based scanning subsystem is arranged near the conveyor belt 63. The item tag scanning system 64 may for example be implemented such as described in FIG. 2 above. The item tag scanning system 64 featuring an EVS sensor is configured to perform an object classification task on the conveyor belt 41 within scene 62. The item tag scanning system 64 comprises a sensing subsystem (see 23 in FIG. 2) with an EVS sensor that observes the scene 62. The sensing subsystem of the item tag scanning system 64 communicates with an onboard processing unit (see 28 in FIG. 2) of the item tag scanning system 64. The output of the sensing subsystem is used by the item tag scanning system 64 in a feedback loop to control motors 65 of the conveyor belt 63, and thus to affect the quality of what is being sensed by the item tag scanning system 64 in the scene 62. Motors 65 drive the conveyor belt 63 and thus determine the speed with which the waste items 61a, b, c are moving on the conveyor belt 63. The system may for example be mounted downwards facing on the conveyor belt 63 where picked up recycling waste is moved forward and sorted by robotic arms (not shown in FIG. 6).

Depending on classification confidence, the conveyor belt can accelerate or slow down, hence improving throughput. For example, if the sensing subsystem of the item tag scanning system 64 determines that a fast and high-quality scan of a waste item 61a, b, c has been captured by the EVS sensor of the item tag scanning system 64, it can infer that the conveyor belt 63 may be moved faster without negatively affecting the image acquisition. This may allow for dramatic speed-up of the waste sorting process. The feedback loop makes the system self-adapting to the inference quality and confidence metric of the classified objects.

Note that the present technology can also be configured as described below:
(1) A system (25, 28, 29) comprising circuitry configured to perform a vision-based registration task, the circuitry (28) being coupled with an event-based vision sensor (26) and being configured to be adaptive to inference quality (24) derived from output of the event-based vision sensor (26) and/or to be adaptive to consistency (34) of a task output (33) of the vision-based registration task.
(2) The system of (1), wherein the circuitry is configured to find the state in which the system performs the vision-based registration task optimally.
(3) The system of (1) or (2), wherein the circuitry is configured to determine a quality metric (24) from the output of the event-based vision sensor, the quality metric (24) being used in a feedback loop to control an actuator (29) and thus affect the quality of what is being sensed by the event-based vision sensor (26).
(4) The system of any one of (1) to (3), wherein the system itself or an object can be moved in its relative position to the system by an actuator (29) which gets control input based on the inference quality (24) derived from output of the event-based vision sensor (26) and/or the consistency (34) of the task output (33).
(5) The system of any one of (1) to (4), wherein the actuator-based optical registration system comprises an EVS-based sensing subsystem (23) which comprises the event-based vision sensor (26).
(6) The system of any one of (1) to (5), wherein the system (51) is moved by an actuator (29), or an object (41, 63) is moved in its relative position to the system by an actuator (29), the actuator getting control input (36) based on the inference quality (24) derived from output of the event-based vision sensor (26) and/or the consistency (34) of the task output (33).
(7) The system of any one of (1) to (6), comprising an EVS-based sensing subsystem (23) which comprises the event-based vision sensor (26), and wherein the EVS-based sensor subsystem (23) uses events measured by EVS sensor (26) to reconstruct item tags and/or navigational cues.
(8) The system of any one of (1) to (7), comprising an EVS-based sensing subsystem (23) which comprises the event-based vision sensor (26), and wherein the EVS-based sensor subsystem (23) is configured to output an inference quality metric (24).
(9) The system of any one of (1) to (8), comprising a conveyor belt (41) which is coupled to an EVS-based sensing subsystem (23), the movement of the conveyor belt (41) being adaptive to inference quality (24) derived from output of the event-based vision sensor (26) and/or to consistency (34) of a task output (33).
(10) The system of any one of (1) to (9), wherein an EVS-based sensing subsystem is implemented onboard a scanning drone (51) or robot, the movement of the scanning drone (51) or robot being adaptive to inference quality (24) derived from output of the event-based vision sensor (26) and/or to consistency (34) of a task output (33).
(11) The system of any one of (1) to (10), wherein the item tags are selected from barcodes, QR codes and April tags and wherein the vision-based registration task comprises a process of tag detection.
(12) The system of any one of (1) to (11), wherein the circuitry is configured to transform (302) an event representation of events obtained from the event-based vision sensor (26).
(13) The system of any one of (1) to (12), wherein the circuitry is configured to perform image reconstruction (303) based on an event stream obtained by the event-based vision sensor (26).
(14) The system of any one of (1) to (13), wherein the circuitry is configured to perform (304) a specified task on reconstructed images (32) to obtain a task output (33).
(15) The system of any one of (1) to (14), wherein the circuitry is configured to perform (305) inference of image quality is performed based on reconstructed images (32) to obtain an image quality metric (24).
(16) The system of any one of (1) to (15), wherein the circuitry is configured to perform (306) a consistency check on the task output (33) to obtain a consistence metric (34)
(17) The system of any one of (1) to (16), wherein the circuitry is configured to perform a control loop based on an image quality metric (24) and/or a consistence metric (34).
(18) The system of any one of (1) to (17), wherein the circuitry is configured to deduce (705) the possibility of the current frame containing an image tag, and/or the circuitry is configured to localize a tag.
(19) An EVS-based sensing subsystem comprising circuitry configured to perform a vision-based registration task, the subsystem comprising an event-based vision sensor (26) and circuitry configured to output an inference quality metric (24) to a processor (28) of a vision-based registration task system (21).
(20) A computer-implemented method for performing a vision-based registration task, the method comprising acquiring (301) output of an event-based vision sensor (26) and adapting a vision-based registration task system (21) to inference quality (24) derived from the output of the event-based vision sensor (26) and/or to a task output (33) of the vision-based registration task performed by the vision-based registration task system (21).
(21) A program comprising instructions, the instructions being configured to, when operated by a processor, perform the method of (20).

### REFERENCE SIGNS

11 pallet racks
12 inventory item
21 Vision-based Registration Task System
22, 62 scene
23 sensing subsystem
24 image quality metric
25 processing unit
26 EVS sensor
27 camera
28 onboard processing unit
29 actuator
32 reconstructed image
34 consistence metric
31, 35, 38 neural network (NN)
36 control signal
41,63 conveyor belt
42, 65 control motors of conveyor belt
43 item tag
51 drone
52 Front-facing EVS camera of drone
53, 54 Sideway-facing EVS cameras of drone
61a, b, c waste item
64 item tag scanning system

1. A system comprising circuitry configured to perform a vision-based registration task, the circuitry being coupled with an event-based vision sensor and being configured to be adaptive to inference quality derived from output of the event-based vision sensor and/or to be adaptive to consistency of a task output of the vision-based registration task.

2. The system of claim 1, wherein the circuitry is configured to find the state in which the system performs the vision-based registration task optimally.

3. The system of claim 1, wherein the circuitry is configured to determine a quality metric from the output of the event-based vision sensor, the quality metric being used in a feedback loop to control an actuator and thus affect the quality of what is being sensed by the event-based vision sensor.

4. The system of claim 1, wherein the system itself or an object can be moved in its relative position to the system by an actuator which gets control input based on the inference quality derived from output of the event-based vision sensor and/or the consistency of the task output.

5. The system of claim 1, wherein the actuator-based optical registration system comprises an EVS-based sensing subsystem which comprises the event-based vision sensor.

6. The system of claim 1, wherein the system is moved by an actuator, or an object is moved in its relative position to the system by an actuator, the actuator getting control input based on the inference quality derived from output of the event-based vision sensor and/or the consistency of the task output.

7. The system of claim 1, comprising an EVS-based sensing subsystem which comprises the event-based vision sensor, and wherein the EVS-based sensor subsystem uses events measured by EVS sensor to reconstruct item tags and/or navigational cues.

8. The system of claim 1, comprising an EVS-based sensing subsystem which comprises the event-based vision sensor, and wherein the EVS-based sensor subsystem is configured to output an inference quality metric.

9. The system of claim 1, comprising a conveyor belt which is coupled to an EVS-based sensing subsystem, the movement of the conveyor belt being adaptive to inference quality derived from output of the event-based vision sensor and/or to consistency of a task output.

10. The system of claim 1, wherein an EVS-based sensing subsystem is implemented onboard a scanning drone or robot, the movement of the scanning drone or robot being adaptive to inference quality derived from output of the event-based vision sensor and/or to consistency of a task output.

11. The system of claim 1, wherein the item tags are selected from barcodes, QR codes and April tags and wherein the vision-based registration task comprises a process of tag detection.

12. The system of claim 1, wherein the circuitry is configured to transform an event representation of events obtained from the event-based vision sensor.

13. The system of claim 1, wherein the circuitry is configured to perform image reconstruction based on an event stream obtained by the event-based vision sensor.

14. The system of claim 1, wherein the circuitry is configured to perform a specified task on reconstructed images to obtain a task output.

15. The system of claim 1, wherein the circuitry is configured to perform inference of image quality is performed based on reconstructed images to obtain an image quality metric.

16. The system of claim 1, wherein the circuitry is configured to perform a consistency check on the task output to obtain a consistence metric.

17. The system of claim 1, wherein the circuitry is configured to perform a control loop based on an image quality metric and/or a consistence metric.

18. The system of claim 1, wherein the circuitry is configured to deduce the possibility of the current frame containing an image tag, and/or the circuitry is configured to localize a tag.

19. An EVS-based sensing subsystem comprising circuitry configured to perform a vision-based registration task, the subsystem comprising an event-based vision sensor and circuitry configured to output an inference quality metric to a processor of a vision-based registration task system.

20. A computer-implemented method for performing a vision-based registration task, the method comprising acquiring output of an event-based vision sensor and adapting a vision-based registration task system to inference quality derived from the output of the event-based vision sensor and/or to a task output of the vision-based registration task performed by the vision-based registration task system.

21. A program comprising instructions, the instructions being configured to, when operated by a processor, perform the method of claim 20.
